(19) United States
(12) Patent Application Publication
(10) Pub. No.: US 2004/0239654 A1
(43) Pub. Date: Dec. 2, 2004

(54) Drive circuit for light emitting elements

(76) Inventor: Yoshiyuki Okuda, Saitama (JP)

Correspondence Address: MORGAN LEWIS & BOCKIUS LLP, 1111 PENNSYLVANIA AVENUE NW, WASHINGTON, DC, 20004, US

(21) Appl. No.: 10/489,703

(22) PCT Filed: Sep. 11, 2002
(86) PCT No.: PCT/JP02/09265

(30) Foreign Application Priority Data
Sep. 20, 2001 (JP) 2001-286064

(51) Int. Cl. G09G 5/00

(52) U.S. Cl. 345/204

(57) ABSTRACT

A display panel includes a number of light emitting cells arranged in a matrix. At least one drive circuit is associated with the light emitting cells. Each cell includes one light emitting element. A current mirror circuit is used in the drive circuit. The current mirror circuit has a primary transistor to drive a reference current source and a secondary transistor to drive the light emitting element. A pulse signal selects one of the primary and secondary transistors alternately. This switching operation by the pulse signal reduces irregularities in mirror ratio between the two transistors in each light emitting cell. As a result, the drive circuit(s) can suppress fluctuations in brightness among the light emitting cells of the display panel.

### TECHNICAL FIELD

This invention relates to a drive circuit for controlling the on/off state of light emitting elements arranged in a matrix on a display panel.

### BACKGROUND ART

Personal computers and data terminals have a display panel that includes a number of light emitting elements (or display cells) to display various types of information such as images and data. The light emitting elements are usually arranged in a matrix. Organic electroluminescent elements (referred to as “organic EL elements” hereinafter) are often used as the light emitting elements. The light emitting elements are generally driven by TFT (Thin Film Transistor) circuits. The TFT circuits can be formed together with the light emitting elements on the display panel.

A pair of neighboring transistors disposed on a general silicon semiconductor wafer have substantially the same characteristics. However, a low-temperature polysilicon TFT drive circuit, which is one of the most common drive circuits for the organic EL elements, has a drawback in that transistors formed on the drive circuit tend to have large irregularities in electric characteristics. In the TFT circuit, therefore, even the neighboring transistors might be very different in mutual inductance (so-called Vg-Id property). Thus, when the TFT drive circuits are used for the organic EL elements of the display panel, drive currents for the respective organic EL elements are not the same. This deteriorates quality of images displayed.

In order to eliminate the irregularities among the organic EL element drive currents, Japanese Patent Application Kokai Nos. 2001-147659 and 2001-85988, published May 29, 2001 and Mar. 30, 2001 respectively, disclosed use of a current mirror circuit. Specifically, a current mirror circuit is used such that the drive current for an organic EL element is replaced with a reference current. This circuitry is schematically illustrated in FIG. 1 of the accompanying drawings.

In FIG. 1, reference symbols Qa and Qb denote a pair of transistors on the TFT circuit. A drain terminal of each transistor is coupled to a power source. A source terminal of the transistor Qa is connected to a reference current source Iref, and a source terminal of the transistor Qb is connected to an organic EL element. The organic EL element is a load. A gate terminal of the transistor Qa is connected to a gate terminal of the transistor Qb. The gate terminal of the transistor Qa is also connected to the source terminal. In this manner, the transistors Qa and Qb form a current mirror circuit. A square of the broken line in FIG. 1 indicates a single cell (or one pixel) in the display panel. In other words, FIG. 1 shows a drive circuit structure for the single cell.

The drive circuit of FIG. 1 operates as follows. The following equation holds true because of a mirror image current effect in the current mirror circuit when drain currents of the transistors Qa and Qb are represented by symbols Ida and Idb:

Ida≈Idb

The drain current of each transistor is substantially the same as the source current. The source current for the transistor Qa is the reference current Iref, and the source current for the transistor Qb is a drive current Iel of the organic EL element. Therefore, the following equations are established:

Ida≈Iref

Idb≈Iel

From the above described equations, the following equation results:

Iref≈Iel

Therefore, the drive current Iel for the organic EL element in the single cell is not influenced by the characteristics of the transistors Qa and Qb situated in the drive circuit, but determined by the value of the reference current source Iref only.

In the drive circuit shown in FIG. 1, the organic EL element drive current Iel becomes equal to the predetermined reference current Iref in each of the cells of the display panel. As a result, it is possible to suppress irregularities, among the cells in emission brightness, to a certain extent.

However, when a low-temperature polysilicon TFT circuit is used, great irregularities appear in characteristics between the neighboring transistors so that the two transistors Qa and Qb of the current mirror circuit shown in FIG. 1 do not have the same electrical characteristics. Accordingly, a mirror ratio, Mr, which represents a ratio of a secondary current (current flowing in the secondary transistor Qb) to a primary current (current flowing in the primary transistor Qa) in the current mirror circuit does not become 1. Ideally, the mirror ratio Mr (=secondary current/primary current) should be 1.

Therefore, even if the primary current, i.e., the reference current Iref, is stable in the current mirror circuit, the secondary current, i.e., the organic EL element drive current Iel, becomes:

Iel=Iref×Mr≠Iref

Consequently, the organic EL element drive currents are not the same among the cells of the display panel. Thus, the cells do not emit light at uniform brightness, and unfavorable patterns appear in the display screen. The display screen having such patterns is sometimes referred to as a “sand-spreading screen.”

### DISCLOSURE OF INVENTION

An object of the present invention is to provide a drive circuit for a light emitting element that can reduce fluctuations in brightness among light emitting cells of a display panel.

According to one aspect of the present invention, there is provided a drive circuit for driving a light emitting element with a current having a predetermined value, comprising: a current mirror circuit including a primary transistor and a secondary transistor; a reference current source for providing the current having the predetermined current value; a switching element for alternately connecting the primary transistor to one of the light emitting element and the reference current source and for alternately connecting the secondary transistor to the other of the light emitting element and the reference current source; and a switchover controller for controlling the switching element to connect the primary transistor to the light emitting element when the secondary transistor is connected to the reference current source, and to connect the primary transistor to the reference current source when the secondary transistor is connected to the light emitting element.

A display panel includes a number of light emitting elements and cells arranged in a matrix. One drive circuit is associated with one light emitting cell. Since the driving circuits can provide uniform drive currents in the respective light emitting cells, it is possible to reduce the fluctuations in brightness among the pixels (cells) and improve the quality of images displayed on the screen.

### BRIEF DESCRIPTION OF DRAWINGS

FIG. 1 illustrates a circuit diagram of a drive circuit for an organic EL element which uses a current mirror circuitry;

FIG. 2 is a circuit diagram showing a drive circuit for an organic EL element in accordance with a first embodiment of the present invention;

FIG. 3 depicts relationship between a mirror ratio variation and a mirror ratio deviation;

FIG. 4 illustrates a drive circuit similar to FIG. 2, but has a TFT structure;

FIG. 5 illustrates a drive circuit for an organic EL element in accordance with a second embodiment of the present invention;

FIG. 6 illustrates a drive circuit similar to FIG. 5, but has a TFT structure;

FIG. 7 illustrates a drive circuit for an organic EL element in accordance with a third embodiment of the present invention; and

FIG. 8 illustrates a drive circuit similar to FIG. 7, but has a TFT structure.

### DETAILED DESCRIPTION OF THE INVENTION

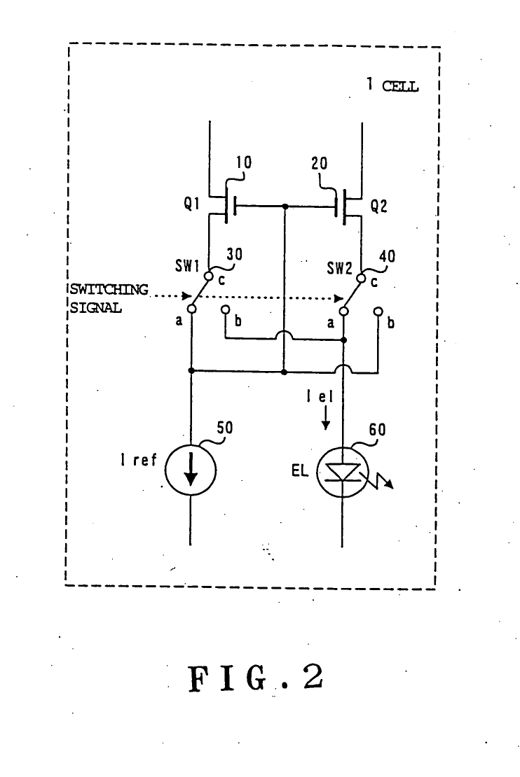

Embodiments of the present invention will be described with reference to FIGS. 2 to 8.

Referring first to FIG. 2, a first embodiment of a drive circuit for an organic EL element according to the present invention is illustrated.

The circuit configuration of the first embodiment will be first described. In FIG. 2, each of elements Q1 (10) and Q2 (20) functions as a TFT transistor element. The TFT transistor element may be a bipolar transistor or FET (Field Effect Transistor). Any element serving as a transistor is called “transistor” in the following description.

Drain terminals of the transistors Q1 (10) and Q2 (20) are coupled to power sources respectively. Gate terminals of the transistors Q1 (10) and Q2 (20) are connected to each other, and to source terminals via switching elements SW1 and SW2 respectively. Therefore, the transistors Q1 (10) and Q2 (20) form a current mirror circuit, and a current substantially equal to a drain current in the primary transistor Q1 (10) is caused to always flow in the secondary transistor Q2 (20) as a drain current.

A switching element SW1 (30) and a switching element SW2 (40) are TFT switching elements. Like the transistor Q1 (or Q2), each switching element SW1 (or SW2) may be a bipolar transistor or FET. The switching elements SW1 (30) and SW2 (40) serve as alternate switching elements, which switch over simultaneously in accordance with a level of a switching signal supplied from a source (not shown). Each switching element includes one common terminal (referred to as “terminal c”) and two independent terminals “a” and “b”. The terminal c is connected to the terminal a/b alternately in accordance with the switching signal level. In this embodiment, the terminal c is coupled to the terminal a when the switching signal level is high, and the terminal c is coupled to the terminal b when the switching signal level is low.

The terminal c of the switching element SW1 (30) is connected to the source terminal of the transistor Q1 (10). The terminal c of the switching element SW2 (40) is connected to the source terminal of the transistor Q2 (20). The terminal a of the switching element SW1 (30) and the terminal b of the switching element SW2 (40) are connected to a reference current source (50), the gate terminal of the transistor Q1 (10) and the gate terminal of the transistor Q2 (20). The terminal b of the switching element SW1 (30) and the terminal a of the switching element SW2 (40) are connected to an organic EL element (60).

The switching operation of the switching element SW1 between the terminal a (reference current source) and the terminal b (organic EL element) takes place preferably at high speed. Likewise, the switching operation of the switching element SW2 between the terminal a (organic EL element) and the terminal b (reference current source) takes place at high speed. The switching operation of the switching element SW1 takes place in synchronization with the switching operation of the switching element SW2.

The reference current source (50) is a constant current circuit, comprising a TFT transistor element, to supply a constant current Iref regardless of a value of voltage applied to the reference current source.

The organic EL element (60) is a light emitting element using organic electroluminescent materials, and emits light when the predetermined drive current Iel flows.

Now the operation of the circuit shown in FIG. 2 will be described.

It should be noted that a display panel includes a number of cells, each cell includes a light emitting element (organic EL element), and at least one of the light emitting elements is selected for light emission. A selection signal supplied to the display panel selects the light emitting element(s).

In this embodiment, a switching signal for the switching elements SW1 (30) and SW2 (40) is a pulse signal having high and low levels alternately. For example, the high level of the pulse signal alternates with the low level for each frame of the display screen or each sub-frame.

It should be assumed that the high level of the pulse signal is first applied to the switching elements SW1 (30) and SW2 (40). As described earlier, the terminal c of the switching element SW1 (30) is connected to the terminal a when the switching signal is at the high level. At the same time, the terminal c of the switching element SW2 (40) is connected to the terminal a. Therefore, the source terminal of the transistor Q1 (10) is coupled to the reference current source (50), and the source terminal of the transistor Q2 (20) is coupled to the organic EL element (60).

As a result, a gate-source voltage appears at the transistor Q1 (10) such that the drain current in the transistor Q1 (10) becomes the current Iref of the reference current value (50). Since the gate terminal of the transistor Q1 is connected to the gate terminal of the transistor Q2, the gate-source voltage is also applied to the transistor Q2. A drain current which corresponds to the gate-source voltage is therefore caused to flow in the transistor Q2. The drain currents of the transistors Q1 and Q2 at this moment are represented by Id1 and Id2. Deviation of the mirror ratio of the current mirror circuit that includes the transistors Q1 and Q2 is represented by x (0≦|x|<<1). Then, the following equation is established:

Id1:Id2=1:(1+x) (1)

Therefore, the difference between the drain currents Id1 and Id2 decreases as the absolute value of the mirror ratio deviation x decreases. If the characteristics of the two transistors Q1 and Q2 in the current mirror circuit are the same, the mirror ratio deviation x is zero, i.e., Id1=Id2.

As described above, the drain current is substantially equal to the source current in each of the primary and secondary transistors in the current mirror circuit. Therefore, by substituting the source currents Iref and Iel for the transistor drain currents Id1 and Id2 respectively, the equation (1) is expressed as follows:

Iel=Iref×(1+x) (2)

It should be assumed now that the switching pulse signal applied to the switching elements SW1 and SW2 changes from the high level to the low level.

On this occasion, the terminal c of the switching element SW1 is switched over to the terminal b from the terminal a, and the terminal c of the switching element SW2 is switched over to the terminal b from the terminal a. Specifically, the source terminal of the transistor Q1 (10) is connected to the organic EL element 60 and the source terminal of the transistor Q2 (20) is connected to the reference current source 50. Then, a gate-source voltage appears at the transistor Q2 and the drain current becomes Iref. This gate-source voltage is also applied to the transistor Q1, and a corresponding drain current is generated in the transistor Q1.

Consequently, the following equation is established between the drive current Iel in the organic EL element 60 and the reference current Iref of the reference current source 50:

Iel=Iref/(1+x) (3)

This equation is obtained in a similar manner as the equations (1) and (2) are obtained.

The switching signal applied to the switching elements SW1 and SW2 is the pulse signal having the alternating high and low levels for each frame of the display screen or each sub-frame, as mentioned above. If a duty factor of the pulse waveform is ½, then the high level has the same period (time length) as the low level.

An average value of the organic EL element drive current Iel per unit time is represented by Iel(AV) in this embodiment. Iel(AV) is then given by the average of the sum of the equations (2) and (3), and the following equation (4) is established:

$$Iel ( AV ) = Iref \times \{ ( 1 + x ) + 1 / ( 1 + x ) \} / 2 \\ = Iref \times \{ 1 + {x}^{2} / 2 \times ( 1 + x ) \} \qquad ( 4 )$$

The mirror ratio deviation x in the equations (2) and (4) can be expressed by the mirror ratio Mr (or Mr(AV)) in the following manner. In other words, the mirror Mr (or Mr(AV)) can be expressed by the mirror ratio deviation x as described below.

As mentioned above, the mirror ratio Mr (or Mr(AV)) is a ratio of the secondary current Iel (or its average Iel(AV)) of the current mirror circuit to the primary current Iref. The mirror ratio deviation x indicates deviation of an actual mirror ratio from the theoretical value (one).

Therefore, the mirror ratio Mr in the equation (2) can be expressed as follows:

Iel=Iref×Mr

∴Mr=1+x

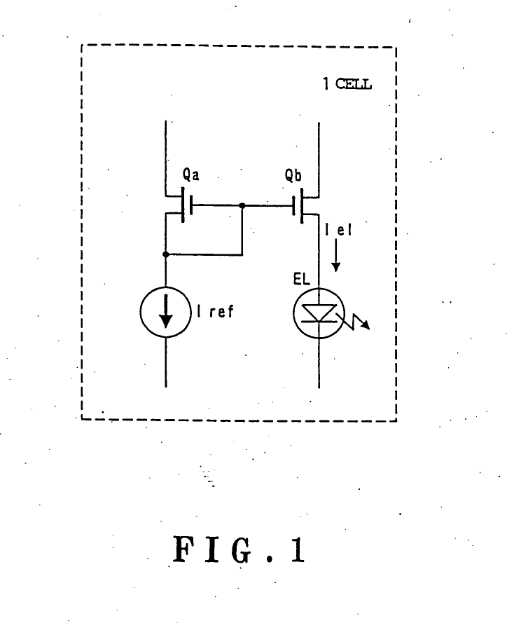

The mirror ratio Mr of this equation is the mirror ratio of the current mirror circuit in the drive circuit shown in FIG. 1.

On the other hand, the mirror ratio Mr(AV) in the equation (4), which represents the embodiment of the invention, can be expressed as follows:

Iel(AV)=Iref×Mr(AV)

∴Mr(AV)=1+x²/2×(1+x)

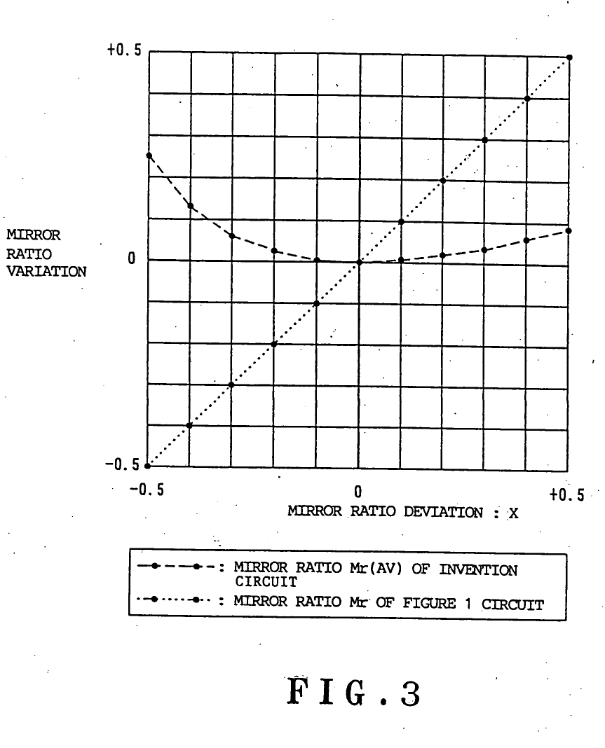

FIG. 3 depicts the mirror ratios Mr and Mr(AV) with respect to the mirror ratio deviation x, which are calculated by the above equations. It is clear from the characteristic curves of FIG. 3 that the mirror ratio Mr(AV) fluctuates significantly less than the mirror ratio Mr.

Therefore, even if the two neighboring transistors (a pair of transistors) in the current mirror circuit using the low-temperature polysilicon TFT have different characteristics and have a large mirror ratio deviation x, it is possible to suppress the mirror ratio variations, which is caused by the mirror ratio deviation, within a very small range by employing the circuitry shown in FIG. 2. In other words, even if the two transistors have different characteristics, the drive current Iel of the organic EL element is very close to the current value Iref of the reference current source. Accordingly, the brightness of the organic EL elements arranged in a matrix on the display panel becomes uniform, and no “sand-spreading” pattern appears on the display screen.

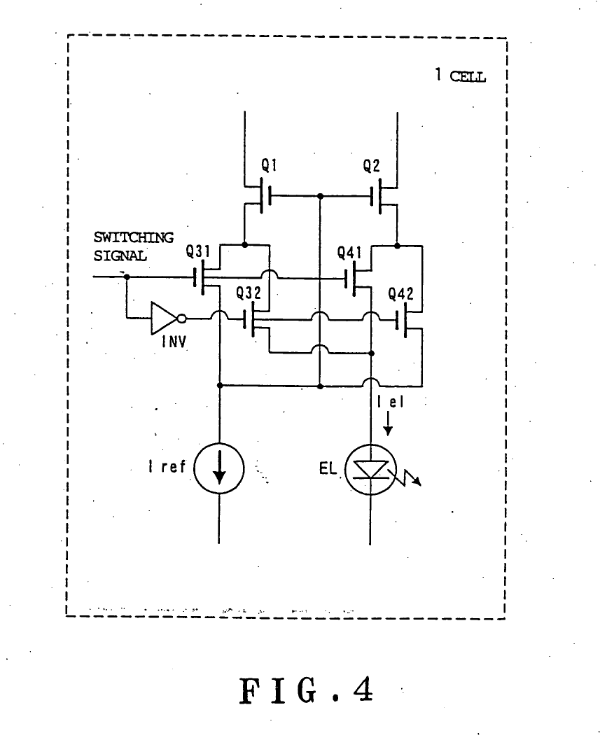

Referring to FIG. 4, an example of a TFT circuit designed on the basis of the circuit of FIG. 2 is illustrated. The transistors Q31 and Q32 and an inverting circuit (INV) of FIG. 4 correspond to the switching element SW1 of FIG. 2. The transistors Q41 and Q42 and the inverting circuit (INV) of FIG. 4 correspond to the switching element SW2 of FIG. 2. Therefore, when the switching signal level is high, the transistors Q31 and Q41 are turned on and the transistors Q32 and Q42 are turned off. On the other hand, when the switching signal level is low, the transistors Q32 and Q42 are turned on and the transistors Q31 and Q41 are turned off.

Other circuit elements, such as the transistors Q1 and Q2, in FIG. 4 will not be described here since they are similar to those illustrated in FIG. 2.

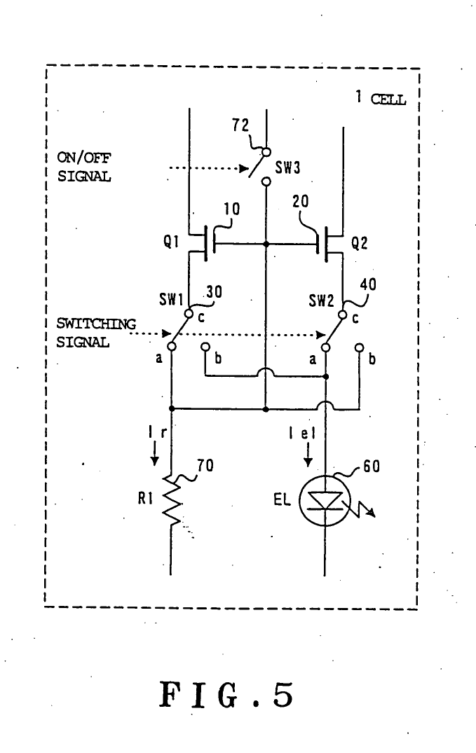

A second embodiment of the present invention will be described with reference to FIG. 5.

Similar reference numerals and symbols are used to designate similar elements in FIGS. 2 and 5, and these elements will not be described in detail.

In the organic EL element drive circuit according to the second embodiment, the transistors Q1 (10) and Q2 (20), the switching elements SW1 (30) and SW2 (40) and the organic EL element (60) are connected in a similar manner to the first embodiment.

One difference between the first and second embodiments lies in that a resistor element RI (70) is used in the place of the reference current source (50). This is because a simple resistor is often substituted for a constant current source in an electronic circuit when a relatively small current flows in the electronic circuit. A typical example of such electronic circuit is a differential amplifier circuit. Another reason is because substituting the resistors for the reference current sources (50) is very practical, since the display panel includes a number of cells and each cell needs the reference current source (50).

It should be noted that a switching element SW3 (72) is explicitly illustrated in FIG. 5. The switching element SW3 turns on and of f the organic EL element in the display cell. The switching element SW3 is included in the circuit of FIG. 2, but not illustrated. The switching element SW3 is controlled by an on/off signal (control signal) from a display control circuit (not shown). The display control circuit is connected to the display panel. One end of the switching element SW3 is connected to the power source, and the other end is connected to the gate terminals of the transistors Q1 (10) and Q2 (20). The gate terminal of the transistor Q1 is connected to the gate terminal of the transistor Q2 (20).

In this embodiment, the primary and secondary transistors of the current mirror circuit are switched over by the switching elements at high speed, and the influence of the mirror ratio deviation is reduced in a similar manner to the first embodiment of FIG. 2. Therefore, the detailed description of the operation of the second embodiment in this regard is omitted.

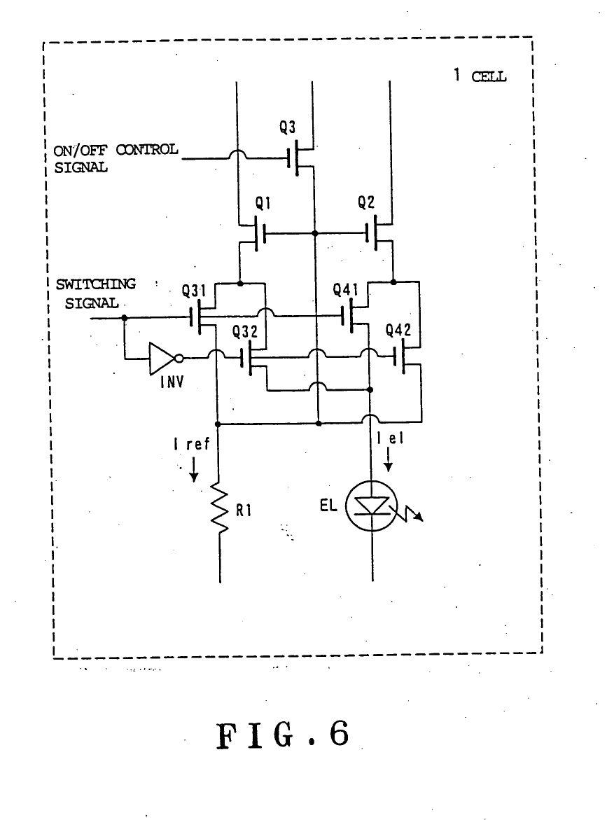

FIG. 6 illustrates an example of a TFT circuit, which is substantially equivalent to the circuit of FIG. 5. The transistors Q31 and Q32 and an inverting circuit (INV) of FIG. 6 correspond to the switching element SW1 of FIG. 5. The transistors Q41 and Q42 and the inverting circuit (INV) of FIG. 6 correspond to the switching element SW2 of FIG. 5. Therefore, when the switching signal level is high, the transistors Q31 and Q41 are turned on and the transistors Q32 and Q42 are turned off. On the other hand, when the switching signal level is low, the transistors Q32 and Q42 are turned on and the transistors Q31 and Q41 are turned off.

The transistor Q3 in FIG. 6 corresponds to the switching element SW3 (72) in FIG. 5.

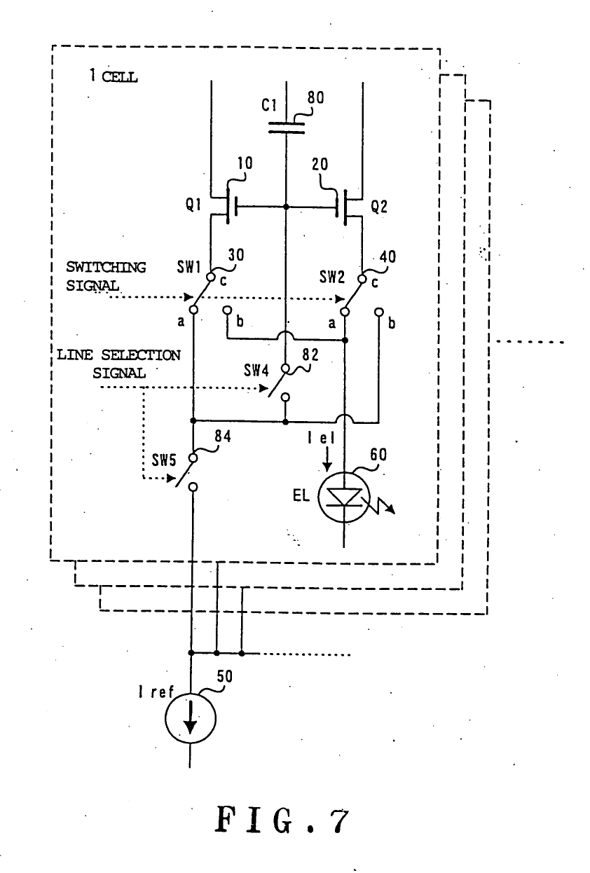

A third embodiment of the present invention will be described with reference to FIG. 7.

Similar reference numerals and symbols are used to designate similar elements in FIGS. 2 and 7, and these elements will not be described in detail.

In the organic EL element drive circuit according to the third embodiment, the reference current source (50) is provided outside the cell such that a plurality of cells of the display panel share the reference current source (50). The reference current source (50) should be highly precise and requires a complicated circuit structure. By sharing one current source (50) with a plurality of cells, it is possible to reduce the total number of the current sources in the display panel. The on/off control of each cell for light emission/extinction is made by controlling the reference current source (50). Accordingly, the switching element SW3 (72) in FIG. 5 is dispensed with.

It should be noted, however, that the reference current Iref is supplied to a target cell from the reference current source (50) only when a line selection signal from an image display control unit (not shown) specifies the target cell by line addressing, since the reference current source (50) is shared by a plurality of cells. Therefore, a voltage holding element should be provided for holding an electrical charge carried by the reference current when the target cell is selected and the reference current Iref is fed to the target cell. This voltage holding element also holds a voltage derived from the electrical charge of the reference current to use the voltage as a gate voltage of the transistor of the current mirror circuit. Further, a switchover element should be provided for connecting the voltage holding element to the reference current source (50) when the target cell is specified by line addressing, and for disconnecting the voltage holding element from the reference current source (50) when another cell is specified by line addressing.

In this embodiment, a capacitor C1 (80) serves as the voltage holding element, and switching elements SW4 (82) and SW5 (84) serve as the switchover element.

Specifically, the line selection signal is applied to the control terminals of the switching elements SW4 and SW5 from the external image display control unit (not shown) such that the on/off control of the switching elements SW4 and SW5 is conducted by the line selection signal. One end of the switching element SW5 (84) is coupled with the reference current source (50), and the other end of the switching element SW5 is coupled with the terminal a of the switching element SW1 (30), the terminal b of the switching element SW2 (40) and one end of the switching element SW4 (82). The other end of the switching element SW4 (82) is coupled with one end of the capacitor C1 (80), the gate terminal of the transistor Q1 (10) and the gate terminal of the transistor Q2 (20). The other end of the capacitor C1 (80) is coupled with the power source.

Other elements and structure of the drive circuit of this embodiment are similar to those of the first and second embodiments. The operation principle of these elements is also the same as the first and second embodiments. Therefore, the description thereof is omitted.

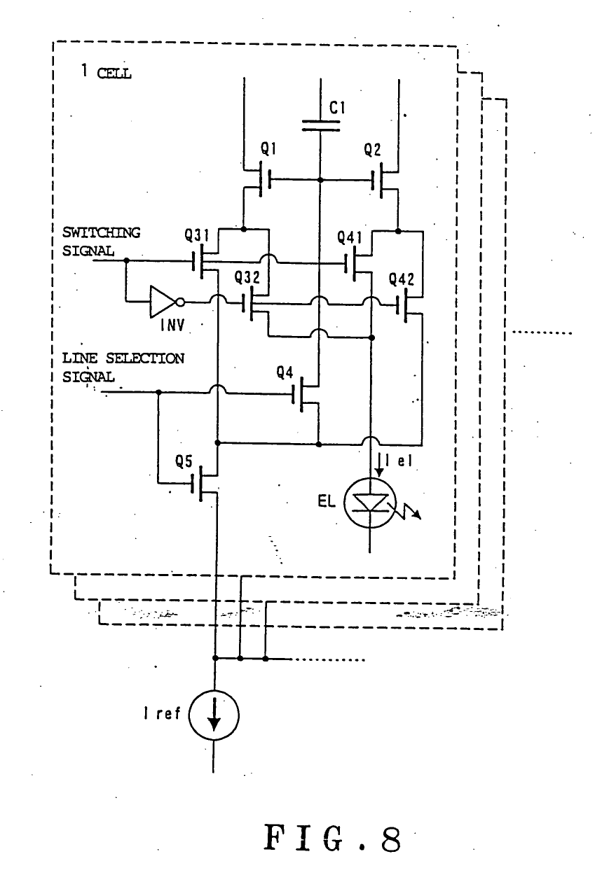

FIG. 8 shows a TFT circuit configured on the basis of the circuit of FIG. 7. The transistors Q31 and Q32 and an inverting circuit (INV) of FIG. 8 correspond to the switching element SW1 of FIG. 7. The transistors Q41 and Q42 and the inverting circuit (INV) of FIG. 8 correspond to the switching element SW2 of FIG. 7. Therefore, when the switching signal level is high, the transistors Q31 and Q41 are turned on and the transistors Q32 and Q42 are turned off. On the other hand, when the switching signal level is low, the transistors Q32 and Q42 are turned on and the transistors Q31 and Q41 are turned off. The transistors Q4 and Q5 in FIG. 8 correspond to the switching elements SW4 and SW5 in FIG. 7.

The organic EL element is utilized as a light emitting element to be driven by the drive circuit in the foregoing embodiments. However, the light emitting element is not limited to an organic EL element. For instance, inorganic EL light emitting elements and light emitting diodes may be used. Liquid crystal display elements are also employable.

This application is based on a Japanese patent application No. 2001-286064 and the entire disclosure thereof is incorporated herein by reference.

1. A drive circuit for driving a light emitting element with a current having a predetermined value, comprising:
a current mirror circuit including a primary transistor and a secondary transistor;
a reference current source for providing the current having the predetermined value;
a switching element for alternately connecting the primary transistor to one of the light emitting element and the reference current source and for alternately connecting the secondary transistor to the other of the light emitting element and the reference current source; and
a switchover controller for controlling the switching element to connect the primary transistor to the light emitting element when the secondary transistor is connected to the reference current source, and to connect the primary transistor to the reference current source when the secondary transistor is connected to the light emitting element.

2. The drive circuit according to claim 1 further including a second switching element for on/off control of the current mirror circuit on the basis of a control signal which provides on/off control of the light emitting element.

3. The drive circuit according to claim 1, wherein the reference current source is a resistor.

4. The drive circuit according to claim 1, wherein the switchover controller controls the switching element in response to a predetermined external signal.

5. The drive circuit according to claim 4, wherein the predetermined external signal is a synchronization signal included in an audiovisual signal supplied to the drive circuit.

6. The drive circuit according to claim 4, wherein the predetermined external signal is a signal in synchronization with a sub-frame, the sub-frame being obtained by dividing an audiovisual signal into a plurality of sub-frames.

7. The drive circuit according to claim 1, wherein said light emitting element is one of an organic electroluminescent light emitting element, an inorganic electroluminescent light emitting element, a light emitting diode, and a liquid crystal display element.

8. The drive circuit according to claim 1, wherein said primary transistor is one of a bipolar transistor and an FET.

9. The drive circuit according to claim 1, wherein the switchover controller permits high speed alternate switching between the light emitting element and the reference current source.

10. An arrangement for driving a plurality of light emitting elements with a current having a predetermined value, comprising:
a reference current source for providing the current having the predetermined value, the reference current source being shared by the plurality of light emitting elements;
a plurality of drive circuits associated with the plurality of light emitting elements respectively;
each drive circuit including:
a current mirror circuit having a primary transistor and a secondary transistor,
a first switching element for alternately connecting the primary transistor of the current mirror circuit to one of the light emitting element and the reference current source and for alternately connecting the secondary transistor to the other of the light emitting element and the reference current source,
a switchover controller for controlling the first switching element to connect the primary transistor of the current mirror circuit to the light emitting element when the secondary transistor is connected to the reference current source, and to connect the primary transistor to the reference current source when the secondary transistor is connected to the light emitting element,
an electrical charge holding element for holding an electrical charge supplied from the reference current source, and applying a voltage corresponding to the electrical charge to a gate of each of the primary and secondary transistors of the current mirror circuit, and
a second switching element for connecting and disconnecting the electrical charge holding element to the reference current source based on a signal selecting the drive circuit.

11. The drive circuit according to claim 10, wherein each switchover controller controls the first switching element in response to a predetermined external signal.

12. The drive circuit according to claim 11, wherein the predetermined external signal is a synchronization signal included in an audiovisual signal supplied to the drive circuit.

13. The drive circuit according to claim 11, wherein the predetermined external signal is a signal in synchronization with a sub-frame, the sub-frame being obtained by dividing an audiovisual signal into a plurality of sub-frames.

14. The drive circuit according to claim 10, wherein said light emitting element is one of an organic electroluminescent light emitting element, an inorganic electroluminescent light emitting element, a light emitting diode, and a liquid crystal display element.

15. The drive circuit according to claim 10, wherein the reference current source is a resistor.

16. The drive circuit according to claim 10, wherein said primary transistor is one of bipolar transistor and an FET.

17. The drive circuit according to claim 10, wherein the switchover controller provides high speed alternate switching between the light emitting element and the reference current source.

18. A display cell for a display panel, comprising:
a current mirror circuit including a primary transistor and a secondary transistor;
a light emitting element, which emits light in response to a predetermined current;
a switching element for alternately connecting the primary transistor to one of the light emitting element and a reference current source and for alternately connecting the secondary transistor to the other of the light emitting element and the reference current source; and
a switchover controller for controlling the switching element to connect the primary transistor to the light emitting element when the secondary transistor is connected to the reference current source, and to connect the primary transistor to the reference current source when the secondary transistor is connected to the light emitting element.

19. The display cell according to claim 18 further including a reference current source for providing the predetermined current.

20. The display cell according to claim 18, wherein the switchover controller provides high speed alternate switching between the light emitting element and the reference current source.
